(19) United States
(12) Patent Application Publication
(10) Pub. No.: US 2003/0131345 A1
(43) Pub. Date: Jul. 10, 2003

(54) Employing value prediction with the compiler

(76) Inventors: Chris Wilkerson, Portland, OR (US); Ryan N. Rakvic, San Jose, CA (US); John P. Shen, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/044,690

(22) Filed: Jan. 9, 2002

(51) Int. Cl. G06F 9/45; G06F 9/30; G06F 15/00

(52) U.S. Cl. 717/156; 712/216; 712/233

(57) ABSTRACT

A method and apparatus for predicting instruction results in a program using the compiler are described. In one embodiment, the method includes creating a data flow graph associated with the program, identifying a target instruction that is to be executed after a producer instruction, and determining that the outcome of the target instruction is dependent on the outcome of the producer instruction using the data flow graph. The outcome of the producer instruction represents a key into a software structure that includes a set of keys and a corresponding set of predicted outcomes of the target instruction. The method further includes inserting an additional instruction that will retrieve a predicted outcome of the target instruction from the software structure based on the outcome of the producer instruction. The additional instruction will be executed after the producer instruction and before the target instruction.

### FIELD OF THE INVENTION

The present invention relates generally to compilers, and more specifically to predicting instruction results in a program using the compiler.

### BACKGROUND OF THE INVENTION

There is a clear trend in high performance processors towards performing operations speculatively, based on predictions. If predictions are correct, the speculatively executed instructions result in improved performance. Existing prediction techniques typically use hardware-based schemes that predict future values of program instructions based on past history associated with the execution of these program instructions. In these predictors, when an instruction (e.g., a branch instruction) is executed, its address and that of the next instruction executed (e.g., the chosen destination of the branch) are stored in a prediction table. Next time the instruction is executed, the prediction table may be indexed using a program counter (PC) to predict which instruction will be executed next so that instruction prefetch can continue.

When the prediction is correct, any dependent instructions that have executed can retire. If the prediction is wrong, the errant instruction and all dependent instructions must be re-executed. This misprediction penalty limits the application of hardware-based value prediction to only the highly predictable instructions. In addition, hardware-based value predictions have significant hardware costs. Value predictors are often on the order of cache sizes before they attain sufficient accuracies and coverage.

Thus, it would be advantageous to provide a value prediction technique that can apply to various instructions and is less expensive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of one embodiment of a computing system;

FIG. 2 is a flow diagram of one embodiment of a process for predicting instruction results in a program using the compiler;

FIGS. 3A-3C illustrate indirect branch prediction, according to one embodiment of the present invention;

FIG. 4 illustrates a portion of a linked list; and

FIGS. 5A-5C illustrate linked list prediction, according to one embodiment of the present invention.

### DESCRIPTION OF EMBODIMENTS

A method and apparatus for predicting instruction results in a program using the compiler are described.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. Instructions are executable using one or more processing devices (e.g., processors, central processing units, etc.).

The algorithms and displays presented herein are not inherently related to any particular computer or other apparatus. Various general purpose machines may be used with programs in accordance with the teachings herein, or it may prove convenient to construct more specialized apparatus to perform the required method steps. The required structure for a variety of these machines will appear from the description below. In addition, the present invention is not described with reference to any particular programming language. It will be appreciated that a variety of programming languages may be used to implement the teachings of the invention as described herein.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

### Overview

The method and apparatus of the present invention provide a technique for predicting instruction results in a program using the compiler. As described above, conventional prediction techniques use hardware-based schemes that predict future values of program instructions based on past history associated with the execution of these program instructions. In these predictors, the misprediction penalty limits the application of value prediction to highly predictable instructions. In addition, these predictors have significant hardware costs because they have to be large in size in order to provide sufficient accuracy.

The technique of the present invention addresses the problems described above through software-based value prediction. Specifically, the prediction technique of the present invention employs the compiler to analyze a data flow graph associated with a program and identify a dependency between two instructions in the program based on the analysis of the data flow graph. The first of the two instructions executes prior to the second instruction and determines the outcome of the second instruction. The first instruction is referred to as a producer instruction, and the second instruction is a referred to as a target instruction. For example, the producer instruction may be “field A=x”, and the target instruction may be “if field A=5 goto routine1, else goto routine2”. During the execution of the program, the producer instruction may be immediately followed by the target instruction or the producer instruction may precede the target instruction by one or more intermediate instructions.

The compiler facilitates prediction of the target instruction's outcome using a software structure that includes a set of keys and a corresponding set of predicted outcomes of the target instruction. Specifically, the compiler inserts an additional instruction after the producer instruction and before the target instruction. This additional instruction contains a command to retrieve a predicted outcome of the target instruction from the software structure using the outcome of the producer instruction as a key into the software structure. As a result, the outcome of the target instruction is known before the target instruction executes, allowing the next instruction to be pre-fetched in advance.

In one embodiment, the compiler also inserts a second additional instruction to update the software structure. The second additional instruction is added after the target instruction to store the outcome of the target instruction with the outcome of the producer instruction in the software structure. The outcome of the producer instruction is stored as a key.

Accordingly, the prediction technique of the present invention uses the actual result of the producer instruction to predict which instruction will be executed after the target instruction, thereby providing more accurate prediction results than the prediction results achieved by conventional predictors that use past history of the target instruction. Furthermore, the compiler's involvement in value prediction optimizations significantly reduces hardware costs associated with the conventional predictors.

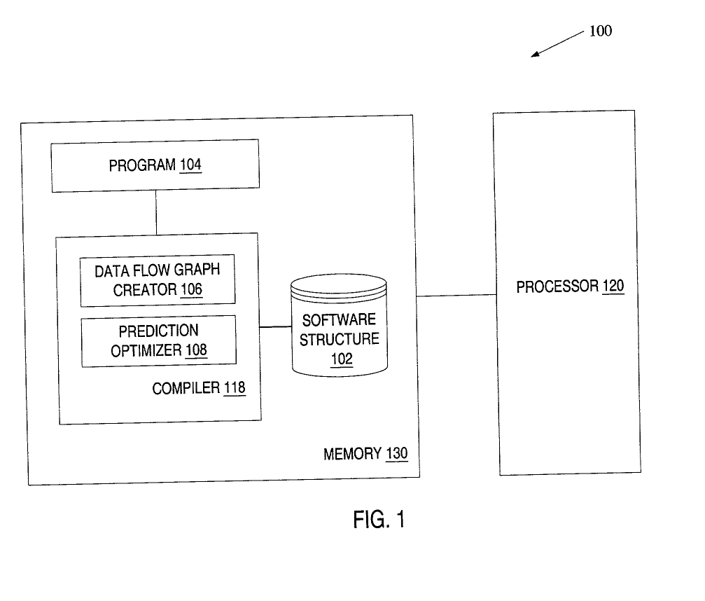

FIG. 1 is a block diagram of one embodiment of a computing system 100. Processing system 100 includes processor 120 and memory 130. Processor 120 is a processor capable of compiling software and executing the resulting object code. Processor 120 is also a processor capable of speculative execution of program instructions. Processor 120 can be any type of processor capable of executing software, such as a microprocessor, digital signal processor, microcontroller, or the like. Processing system 100 can be a personal computer (PC), mainframe, handheld device, portable computer, set-top box, or any other system that includes software.

Memory 130 can be a hard disk, a floppy disk, random access memory (RAM), read only memory (ROM), flash memory, or any other type of machine medium readable by processor 120. Memory 130 can store instructions for performing the execution of the various method embodiments of the present invention.

Memory 130 stores a program 104, a compiler 118 to compile program 104 and create object code, and a software structure 102 to store predicted outcomes of target instructions contained in program 104.

In one embodiment, compiler 118 includes a data flow graph creator 106 and a prediction optimizer 108. Data flow graph creator 106 is responsible for creating a data flow graph associated with program 104 and analyzing the data flow graph to identify a producer instruction that defines an outcome of a target instruction. For example, when the target instruction is a branch instruction, the outcome of the producer instruction defines which instruction will be executed after the branch instruction (i.e., the destination of the branch). In the example above, if the producer instruction is “field A=x”, and the target instruction is “if field A=5 goto routine1, else goto routine2”, the outcome of the producer instruction (i.e., the value of field A) defines whether routine1 or routine2 will be executed after the target instruction.

Prediction optimizer 108 is responsible for implementing the prediction optimizations of program 104. The prediction optimizations are implemented by inserting additional instructions facilitating value prediction of target instructions. First additional instruction includes a command to retrieve a predicted outcome of the target instruction from software structure 102 using the outcome of the producer instruction as a key into software structure 102. This instruction will be executed after the producer instruction and before the target instruction to allow the instruction following the target instruction to be pre-fetched in advance. In one embodiment, the execution of the additional instruction precedes the execution of the target instruction by one or more intermediate instructions.

In one embodiment, prediction optimizer 108 also inserts a second additional instruction, which includes a command to store the outcome of the target instruction with the corresponding outcome of the producer instruction in software structure 102 each time these instructions are executed. The second additional instruction will be executed after the actual execution of the target instruction. Accordingly, software structure 108 will store various outcomes of the producer instruction that occurred during program executions and the most recent outcome of the target instruction for each of these outcomes of the producer instruction. In one embodiment, software structure 108 is a lookup table. In one embodiment, compiler 118 controls the size of software structure 102 and stores only the frequent results.

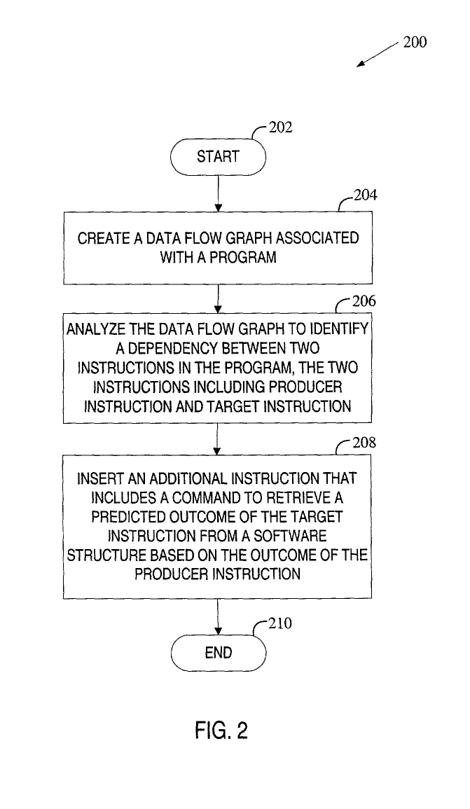

FIG. 2 is a flow diagram of one embodiment of a process 200 for predicting instruction results in a program using the compiler.

Referring to FIG. 2, process 200 begins with the compiler creating a data flow graph associated with a program (processing block 204). At processing block 206, the data flow graph is analyzed to identify a dependency between two instructions in the program. The first of the two instructions is a producer instruction, which executes prior to the second instruction and defines the outcome of the second instruction. The outcome of the second instruction, which is a target instruction for prediction, determines which instruction will be executed after the target instruction.

During the execution of the program, the producer instruction may be immediately followed by the target instruction, or the producer instruction may precede the target instruction by one or more intermediate instructions. The outcome of the second instruction represents a key into a software structure that includes a set of keys and a corresponding set of predicted outcomes of the target instruction.

At processing block 208, the compiler inserts an additional instruction that includes a command to retrieve a predicted outcome of the target instruction from the software structure based on the outcome of the producer instruction. Specifically, the outcome of the producer instruction is used as a key into the software structure to find a predicted outcome associated with this key in the software structure. This additional command will be executed after the producer instruction (to be able to use the actual outcome of the producer instruction as the key into the software structure) and before the target instruction (to allow the instruction following the target instruction to be pre-fetched before the execution of the target instruction is completed).

In one embodiment, the compiler also inserts a second additional instruction to update the software structure with the actual outcome of the target instruction every time the target instruction executes. The second additional instruction is added for execution after the target instruction.

The target instruction may be any instruction that has two or more destinations. An example of such target instruction is a branch instruction. The branch instruction may be a conditional branch instruction or an indirect branch instruction. A conditional branch instruction may be followed by either a true path or a false path. An indirect branch instruction (e.g., a case-switch statement in C code) may be followed by one of the two or more paths.

Another example of the target instruction is a linked list load instruction. A linked list is a dynamic data structure that consists of a group of items, in which each item points to the next item. A linked list load instruction loads a linked list item from memory and determines which linked list item will be loaded next using a pointer contained in the prior linked list item. Accordingly, if the producer instruction produces a pointer to a first linked list item, this pointer can be used to predict which linked list item will be loaded after the first linked list item (i.e., predicting the pointer to a second linked list item) prior to loading the first linked list item.

The prediction technique of the present invention will now be illustrated using exemplary scenarios of indirect branch prediction and linked list prediction.

### Indirect Branch Prediction

One example of an indirect branch instruction is a case-switch statement in C code. If a case-switch statement is not highly biased, its outcome is unpredictable based on previous history of the case-switch statement. As will be illustrated below, such case-switch statement is predictable based on the data value of a variable associated with the case-switch statement.

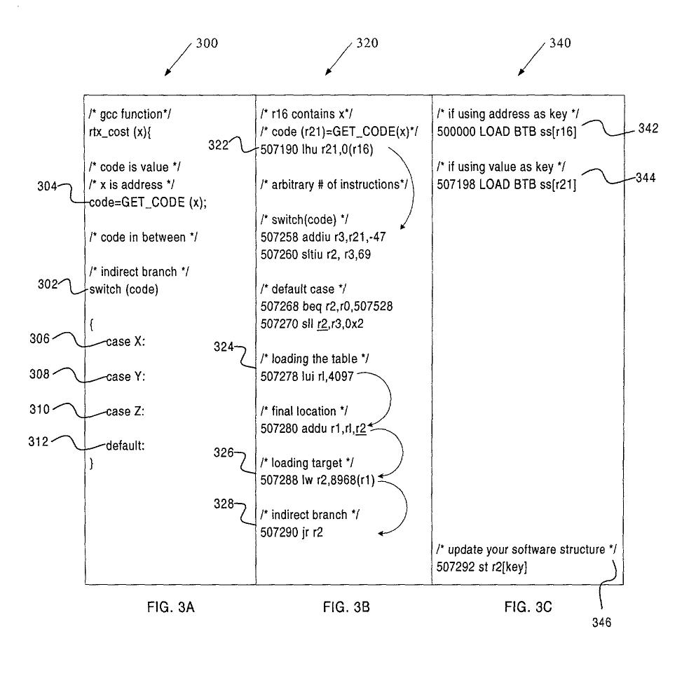

FIG. 3A illustrates an example of partial source code of a “gcc” function that uses a switch statement 302. Prior to switch statement 302, the value of a variable “code” is obtained from a memory location “x” using instruction 304. The value of “code” defines which one of paths 306 through 312 will be taken after switch statement 302.

FIG. 3B illustrates assembly code created by the compiler during the compilation of the source code of FIG. 3A. FIG. 3C illustrates additional instructions generated by the compiler to implement prediction optimization.

The compiler knows when the value of the switch variable “code” is being computed and where it is stored. As shown in FIG. 3B, instruction 322 loads the value of the switch variable into a register (r21) prior to the execution of branch instruction 328.

Referring to FIG. 3C, in one embodiment, the compiler generates instruction 344 which uses the register value (r21) as a key into the software structure to retrieve a corresponding predicted outcome of the case-switch statement (i.e., a predicted destination of the indirect branch) from the software structure. Instruction 344 loads the predicted value retrieved from the software structure into a Branch Target Buffer (BTB) (i.e., a register designated to store the predicted outcome of a branch in a processor). It should be noted that any structure known in the art other than the BTB can be used to store the predicted outcome of the branch.

Instruction 344 can be added to code 320 anywhere after instruction 322, which loads the switch value into a register, and before branch instruction 328. If instruction 344 is added immediately before branch instruction 328, the prediction will be one hundred percent accurate (not considering compulsory misses) but the prediction value may not be loaded into a processor's structure such as the BTB in time (i.e., before the branch is fetched). Alternatively, instruction 344 can be added immediately after instruction 322, ensuring that the prediction value is loaded into the BTB in time. This position of instruction 344 may result in misprediction if any intermediate instruction updates the switch value stored in the register. In one embodiment, all intermediate instructions are analyzed to determine the best location of instruction 344. For example, if only the first intermediate instruction updates the register value, instruction 344 will be inserted right after the first intermediate instruction.

In another embodiment, other identifiers that lead to a predicted value can be used as a key into the software structure instead of the actual switch value. One of such identifiers is address “x” of switch value “code”. Instruction 342 uses address “x” that is stored in register r16 as a key into the software structure. In this embodiment, the software structure stores addresses of outcome values of the producer instruction with corresponding predicted outcomes of the indirect branch instruction. If the address of the switch value is determined before the switch value itself, the compiler can insert instruction 342 even before instruction 322.

In one embodiment, an algorithm is provided to determine which identifier should be used as a key into the software structure and to define the most beneficial location for instruction 344 or 342 within the code 320.

The compiler also generates an instruction 346, which is placed after indirect branch instruction 328, to update the software structure with the actual switch value.

Accordingly, the prediction technique of the present invention increases the accuracy of indirect branch prediction by using an actual data value that determines the outcome of the indirect branch, rather than the past history associated with the indirect branch. The prediction technique of the present invention is controlled by the compiler, which forms the dependency chain between the instructions and can, therefore, easily determine which data values should be used for the prediction.

One of the reasons why accurate indirect branch prediction is important pertains to misprediction penalty. For example, returning to FIG. 3B, instruction 326 loads a location, to which an indirect branch will jump, into a register prior to the execution of branch instruction 328. The location is stored in a table, which also needs to be loaded (instruction 324) prior to the execution of branch instruction 328. These instructions, which are dependent on each other, worsen the misprediction penalty.

### Linked List Prediction

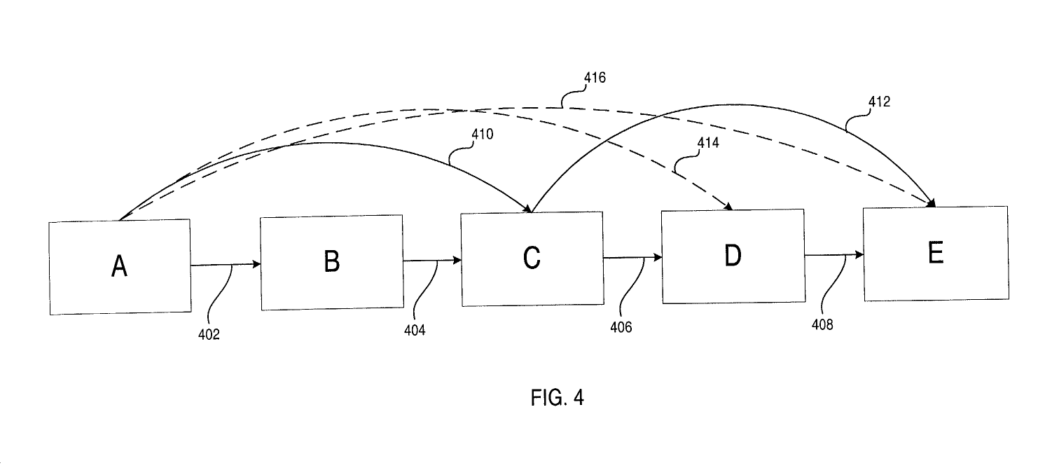

FIG. 4 illustrates a portion of a linked list that includes items A, B, C, D and E. Item A includes a pointer 402 to item B, item B includes a pointer 404 to item C, item C includes a pointer 406 to item D, and item D include a pointer 408 to item E. Accordingly, the linked list can be loaded by sequentially loading one item after another.

In one embodiment, linked list items are loaded in parallel using speculative pointers. That is, the compiler identifies values that can be used as keys into a software structure and inserts an additional load instruction that retrieves a speculative pointer from the software structure based on a specific key. As will be described below, this instruction can be executed in parallel with another instruction, increasing Memory Level Parallelism (MLP). In one embodiment, the compiler identifies a place within the program where two or more instructions can be executed in parallel.

The software structure stores a set of keys and a set of corresponding speculative pointers. For example, if an instruction determines a pointer to item A, this pointer can be stored as a key in the software structure with a corresponding speculative pointer 410 to item C. This speculative pointer 410 was obtained during a prior execution of the program. In another example, the software structure may also store a pointer 404 to item C as a key with a corresponding speculative pointer 412 to item E.

In one embodiment, the software structure may store multiple speculative pointers for each key. For example, each pointer to item A can be stored with multiple corresponding speculative pointers: a speculative pointer 410 to item C, a speculative pointer 414 to item D and a speculative pointer 416 to item E.

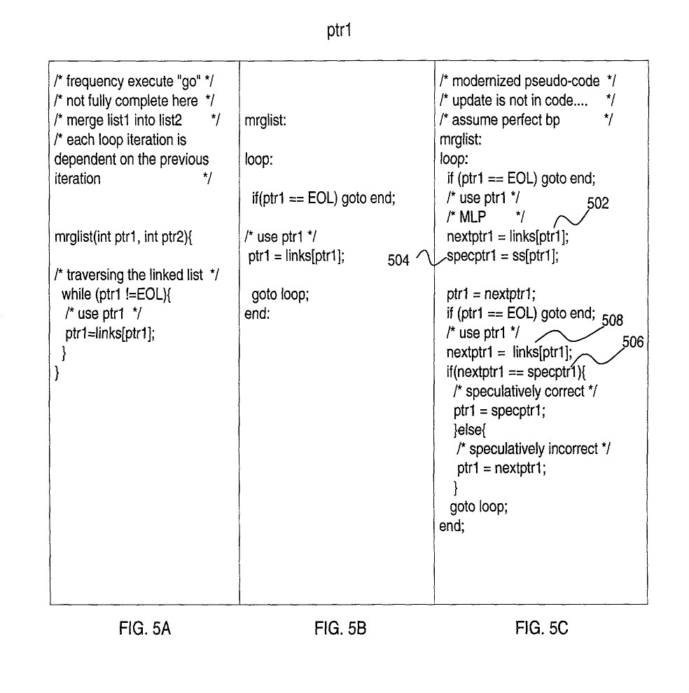

FIG. 5A is a partial source code for function “mrglist” used by function “go”. Function “mrglist” merges linked list 1 into linked list 2. Ptr1 is the pointer that is traversing the linked list. FIG. 5B illustrates the pseudo-code for the source code of FIG. 5A. FIG. 5C illustrates the adjusted pseudo-code that includes prediction optimizations implemented by the compiler.

Referring to FIG. 5C, instruction 502 and 504 load corresponding linked list items and can be executed in parallel to increase the MLP. For example, instruction 502 may determine the actual pointer 402 to item B based on the pointer to item A. Instruction 504 may determine a speculative pointer 410 to item C by retrieving it from the software structure using the pointer to item A as a key. The validation of the speculative pointer 410 may be done by instruction 506 after the real value of pointer 404 is loaded by instruction 508.

In one embodiment, illustrated in FIG. 5C, an assumption is made that the value prediction is correct to be able to continue loading the next two items. For example, loading of items D and C may begin while the real item C is being loaded.

In one embodiment, the values of linked list items are used instead of the pointers. That is, the software structure stores predicted values of linked list items rather than speculative pointers to these items. A predicted value of a required linked list item can be retrieved from the software structure using a key that can be either a pointer to a prior linked list item or the value of the prior linked list item.

In one embodiment, three or more linked list items are loaded in parallel using the software structure that maintains predictions of multiple linked list items for each key.

In one embodiment, the compiler identifies all functions in which the linked list is modified to improve the accuracy of prediction.

It should be noted that indirect branch instructions and linked list instructions represent a few examples of instructions that can be targets for prediction using the prediction technique of the present invention. It should be noted, however, that the prediction technique of the preset invention can be applied to any instruction type other than the indirect branch and linked list without loss of generality.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
creating a data flow graph associated with a program;
identifying a first instruction that is to be executed after a second instruction;
determining that an outcome of the first instruction is dependent on an outcome of the second instruction based on the data flow graph, the outcome of the second instruction representing a key into a software structure that includes a set of keys and a corresponding set of predicted outcomes of the first instruction; and
inserting a third instruction to be executed after the second instruction and before the first instruction, wherein the third instruction is to retrieve a predicted outcome of the first instruction from the software structure based on the outcome of the second instruction.

2. The method of claim 1 wherein the second instruction precedes the first instruction during the execution of the program by one or more intermediate instructions.

3. The method of claim 1 wherein the software structure is a lookup table.

4. The method of claim 1 wherein each predicted outcome in the software structure is an outcome resulted from a last execution of the first instruction when an outcome of the second instruction was equal to a key associated with said each predicted outcome in the software structure.

5. The method of claim 4 further comprising:
inserting a fourth instruction to be executed after the first instruction, the fourth instruction is to update the software structure with the value resulted from the execution of the first instruction with the corresponding outcome of the second instruction.

6. The method of claim 1 wherein the first instruction is a branch instruction.

7. The method of claim 6 wherein the branch instruction is any one of an indirect branch instruction and a direct branch instruction.

8. The method of claim 6 wherein the outcome of the second instruction is a value that determines the outcome of the first instruction.

9. The method of claim 6 wherein the outcome of the second instruction is a data address of a value that determines the outcome of the first instruction.

10. The method of claim 1 wherein the first instruction is a linked list instruction.

11. The method of claim 10 wherein:
each key in the software structure is a pointer to a producer item in a linked list; and
a predicted outcome corresponding to said each key in the software structure is a predicted pointer to a target item in the linked list;
wherein the producer item precedes the target item in the linked list by one or more intermediate items.

12. The method of claim 11 wherein:
the third instruction is to retrieve the predicted pointer of the target item from the software structure; and
the third instruction is to be executed in parallel with one or more instructions that obtain pointers to the one or more intermediate items.

13. The method of claim 10 wherein:
each key in the software structure is a value of a producer item in a linked list; and
a predicted outcome corresponding to said each key in the software structure is a predicted value of a target item in the linked list;
wherein the producer item precedes the target item in the linked list by at least on e intermediate item.

14. An apparatus comprising:
a software structure to store a set of keys and a corresponding set of predicted outcomes of a target instruction; and
a compiler, coupled to the software structure, comprising:
a data flow graph creator to create a data flow graph associated with a program containing the target instruction that is to be executed after a producer instruction and to determine that an outcome of the target instruction is dependent on an outcome of the producer instruction based on the data flow graph, the outcome of the producer instruction representing a key into the software structure; and
a prediction optimizer to insert a first additional instruction to be executed after the producer instruction and before the target instruction, wherein the first additional instruction is to retrieve a predicted outcome of the target instruction from the software structure based on the outcome of the producer instruction.

15. The apparatus of claim 14 wherein the producer instruction precedes the target instruction during the execution of the program by one or more intermediate instructions.

16. The apparatus of claim 14 wherein the software structure is a lookup table.

17. The apparatus of claim 14 wherein each predicted outcome in the software structure is an outcome resulted from a last execution of the target instruction when an outcome of the producer instruction was equal to a key associated with said each predicted outcome in the software structure.

18. The apparatus of claim 17 wherein the prediction optimizer is further to insert a second additional instruction to be executed after the target instruction, the second additional instruction is to update the software structure with the value resulted from the execution of the target instruction with the corresponding outcome of the producer instruction.

19. The apparatus of claim 14 wherein the target instruction is a branch instruction.

20. The apparatus of claim 14 wherein the target instruction is a linked list instruction.

21. A system comprising:
a compiler, coupled to the software structure, to create a data flow graph associated with a program containing a target instruction that is to be executed after a producer instruction, to determine that an outcome of the target instruction is dependent on an outcome of the producer instruction based on the data flow graph, the outcome of the producer instruction representing a key into a software structure storing a set of keys and a corresponding set of predicted outcomes of the target instruction, and to insert a first additional instruction to be executed after the producer instruction and before the target instruction, wherein the first additional instruction is to retrieve a predicted outcome of the target instruction from the software structure based on the outcome of the producer instruction;
a memory to store the program, the software structure and the compiler; and
a processor, coupled to the memory, to execute the compiler.

22. The system of claim 21 wherein the producer instruction precedes the target instruction during the execution of the program by one or more intermediate instructions.

23. The system of claim 22 wherein each predicted outcome in the software structure is an outcome resulted from a last execution of the target instruction when an outcome of the producer instruction was equal to a key associated with said each predicted outcome in the software structure.

24. The system of claim 23 wherein the prediction optimizer is further to insert a second additional instruction to be executed after the target instruction, the second additional instruction is to update the software structure with the value resulted from the execution of the target instruction with the corresponding outcome of the producer instruction.

25. The system of claim 21 wherein the target instruction is a branch instruction.

26. The system of claim 21 wherein the target instruction is a linked list instruction.

27. A computer readable medium comprising executable instructions which when executed on a processing system cause said processing system to perform a method comprising:
creating a data flow graph associated with a program;
identifying a first instruction that is to be executed after a second instruction;
determining that an outcome of the first instruction is dependent on an outcome of the second instruction based on the data flow graph, the outcome of the second instruction representing a key into a software structure that includes a set of keys and a corresponding set of predicted outcomes of the first instruction; and
inserting a third instruction to be executed after the second instruction and before the first instruction, wherein the third instruction is to retrieve a predicted outcome of the first instruction from the software structure based on the outcome of the second instruction.

28. The computer readable medium of claim 27 wherein the second instruction precedes the first instruction during the execution of the program by one or more intermediate instructions.

29. The computer readable medium of claim 27 wherein the first instruction is any one of a branch instruction and linked list instruction.
